(19) United States
(12) Patent Application Publication
(10) Pub. No.: US 2022/0102069 A1
(43) Pub. Date: Mar. 31, 2022

(54) TRANSCEIVING INDUCTION COIL DEVICE FOR WIRELESS CHARGING

(71) Applicant: Taiwan Inpaq electronic Co., Ltd., Miaoli County (TW)

(72) Inventor: SHUO-KUO HONG, Keelung City (TW)

(21) Appl. No.: 17/469,889

(22) Filed: Sep. 9, 2021

(30) Foreign Application Priority Data
Sep. 26, 2020 (TW) 109212740

(51) Int. Cl. H01F 38/14; H02J 50/00; H02J 50/40; H02J 50/10; H01F 27/28

(52) U.S. Cl. CPC H01F 38/14; H02J 50/005; H01F 27/2823; H02J 50/10; H02J 50/402

(57) ABSTRACT

A transceiving induction coil device for wireless charging is provided, which includes a transmitting assembly and a receiving assembly. The transmitting assembly includes a first coil portion and a magnetic housing. The first coil portion is arranged on the magnetic housing and formed by winding one flat wire. The receiving assembly includes a second coil portion. The receiving assembly and the transmitting assembly are coupled to each other. The transmitting assembly is located below the receiving assembly, and a predetermined distance is defined therebetween. The transmitting assembly can also include the magnetic housing and multiple ones of the first coil portion that are arranged on the magnetic housing in a stacked manner. Each first coil portion is formed by winding the flat wire. The receiving assembly includes multiple ones of the second coil portion that are stacked upon each other.

### CROSS-REFERENCE TO RELATED PATENT APPLICATION

This application claims the benefit of priority to Taiwan Patent Application No. 109212740, filed on Sep. 26, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a transceiving induction coil device for wireless charging, and more particularly to a transceiving induction coil device for wireless charging that is manufactured from a flat wire.

### BACKGROUND OF THE DISCLOSURE

As shown in FIG. 1A and FIG. 1B, coils of a conventional wireless charging device are formed by winding a multi-strand wire C1 or a single-core wire C2. While minimization of a direct current resistance (DCR) is essential to the manufacturing of the coils of the wireless charging device, electrical properties such as inductance (L) and quality factor (Q) need to be upheld at the same time. The smaller the DCR is, the larger a coil diameter is required to be. However, such a configuration is difficult to implement in a limited mechanical space resulting from electronic products becoming more lightweight and compact.

Therefore, how to minimize the direct current resistance (DCR) whilst upholding electrical properties such as the inductance (L) and the quality factor (Q) through improving a structural design of charging coils, so as to overcome the above-mentioned deficiencies, has become one of the important issues in the industry.

### SUMMARY OF THE DISCLOSURE

In response to the above-referenced technical inadequacies, the present disclosure provides a transceiving induction coil device for wireless charging.

In one aspect, the present disclosure provides a transceiving induction coil device for wireless charging, which includes a transmitting assembly and a receiving assembly. The transmitting assembly includes a first coil portion and a magnetic housing, and the first coil portion is arranged on the magnetic housing. The first coil portion is formed by winding one flat wire. The receiving assembly includes a second coil portion. The receiving assembly and the transmitting assembly are coupled to each other, the transmitting assembly is located below the receiving assembly, and a predetermined distance is defined between the transmitting assembly and the receiving assembly.

In another aspect, the present disclosure provides a transceiving induction coil device for wireless charging, which includes a transmitting assembly and a receiving assembly. The transmitting assembly includes a plurality of first coil portions and a magnetic housing. The plurality of first coil portions are arranged on the magnetic housing in a stacked manner, and the plurality of first coil portions are each formed by winding one flat wire. The receiving assembly includes a plurality of second coil portions that are stacked upon each other. The receiving assembly and the transmitting assembly are coupled to each other. The transmitting assembly is located below the receiving assembly, and a predetermined distance is defined between the transmitting assembly and the receiving assembly.

Therefore, one of the beneficial effects of the present disclosure is that, in the transceiving induction coil device for wireless charging provided by the present disclosure, by virtue of “the first coil portion of the transmitting assembly being formed by winding one flat wire” and “the second coil portion of the receiving assembly being formed by winding another flat wire”, a direct current resistance (DCR) can be minimized, and optimization of electrical properties such as inductance (L) and quality factor (Q) can be achieved at the same time.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1A and FIG. 1B are schematic cross-sectional views of a coil in a conventional transceiving induction coil device for wireless charging;

FIG. 2 is a schematic top view of a transmitting assembly in a transceiving induction coil device for wireless charging according to the present disclosure;

FIG. 3 is a schematic view of a cross-section taken along line III-III of FIG. 2 according to a first embodiment of the present disclosure;

FIG. 4 is a schematic view of the cross-section taken along line III-III of FIG. 2 according to a second embodiment of the present disclosure;

FIG. 5 is a schematic view of the transceiving induction coil device for wireless charging according to the first embodiment of the present disclosure; and

FIG. 6 is a schematic view of the transceiving induction coil device for wireless charging according to the second embodiment of the present disclosure.

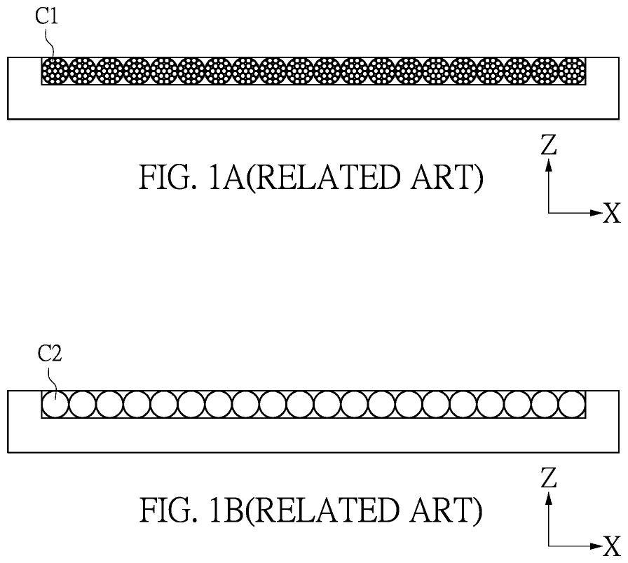

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like. In addition, the term “or” used herein may include, depending on the actual situation, a combination of any one or more than one of the listed items that are associated.

Furthermore, the term “connect” in the present disclosure indicates that there is a physical connection between two components (which can be a direct or an indirect connection). The term “couple” in the present disclosure indicates that the two components are separate from each other and there is no physical connection. Instead, an electric field energy generated by an electric current of one component can activate the electric field energy of another component.

### First Embodiment

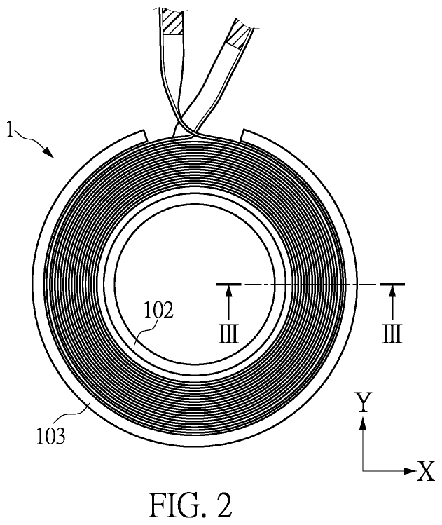

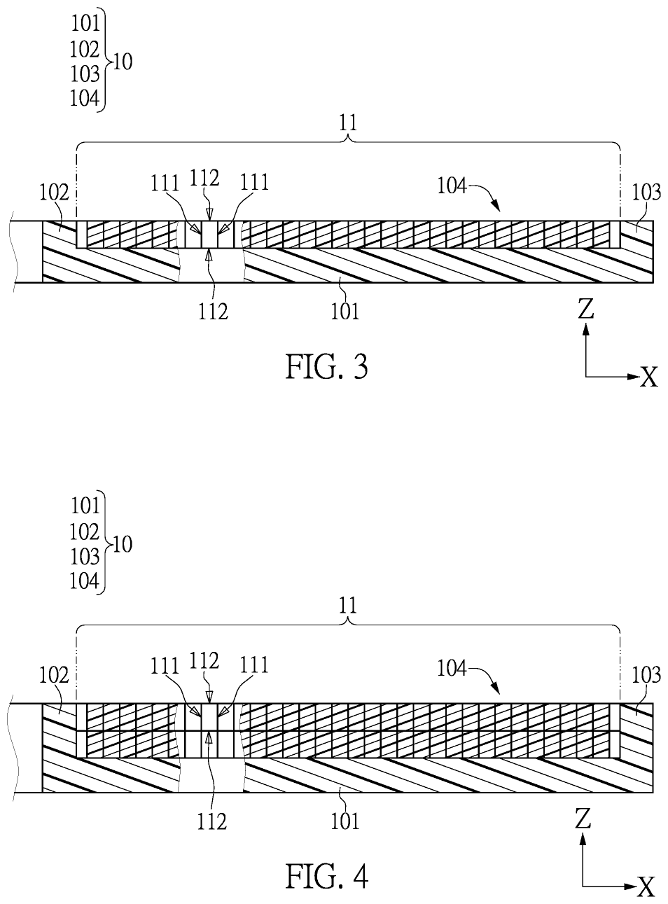

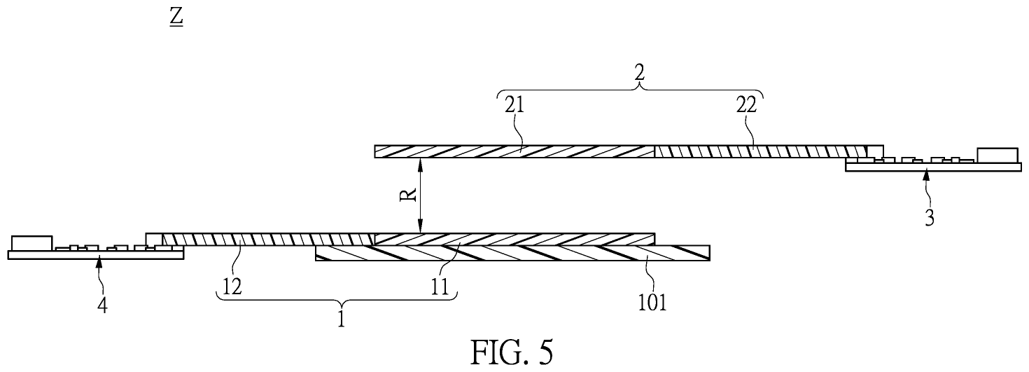

Reference is made to FIG. 2, FIG. 3, and FIG. 5, in which FIG. 2 is a schematic top view of a transmitting assembly in a transceiving induction coil device for wireless charging according to the present disclosure, FIG. 3 is a schematic view of a cross-section taken along line III-III of FIG. 2 according to a first embodiment of the present disclosure, and FIG. 5 is a schematic view of the transceiving induction coil device for wireless charging according to the first embodiment of the present disclosure. Firstly, as shown in FIG. 5, the first embodiment of the present disclosure provides a transceiving induction coil device for wireless charging Z, which includes a transmitting assembly 1 and a receiving assembly 2. The transmitting assembly 1 includes a magnetic housing 10 and a first coil portion 11. The receiving assembly 2 includes a second coil portion 21. The transmitting assembly 1 and the receiving assembly 2 are coupled to each other. The transmitting assembly 1 is located below the receiving assembly 2, and a predetermined distance R is defined between the transmitting assembly 1 and the receiving assembly 2.

For example, as shown in FIG. 5, the transmitting assembly 1 is arranged inside a device, e.g., a charging base, and is connected to a circuit board 4 inside the charging base via a connection portion 12. The receiving assembly 2 is arranged inside a device, e.g., a mobile phone, and is connected to a circuit board 3 inside the mobile phone via a connection portion 22. When electric power is fed into the transmitting assembly 1 at a charging dock, the first coil portion 11 of the transmitting assembly 1 emits magnetic field lines due to electromagnetic induction, which are converted into induced voltages by the second coil portion 21 of the receiving assembly 2 inside the mobile phone, so as to charge the mobile phone.

The material of the magnetic housing 10 mainly includes ferrite, and ferrite mainly has an effect of magnetic isolation and shielding and of magnetic permeability and resistance reduction. Magnetic isolation and shielding refers to reducing the magnetic field lines that emit outwardly, so as to reduce influence on surrounding metal objects and prevent occurrence of eddy currents and signal interference. Magnetic permeability and resistance reduction refers to increasing a coupling coefficient of the first coil portion 11 and the second coil portion 21, so as to improve magnetoelectric conversion efficiency. When a coil having a higher inductance is configured with fewer turns (or windings) of the coil, electrical resistance of the coil can be reduced, and efficiency reduction due to heat is less likely to happen.

Referring further to FIG. 2 and FIG. 3, a detailed structure of the transmitting assembly 1 is illustrated. The first coil portion 11 is arranged on the magnetic housing 10, and the first coil portion 11 is formed by winding one flat wire. The flat wire is different from a single-core wire or a multi-strand wire, and a cross-section thereof (as shown in FIG. 3) has a rectangular shape. The magnetic housing 10 includes a base 101, an inner peripheral wall 102, and an outer peripheral wall 103. The inner peripheral wall 102 is arranged at a center of the base 101. The outer peripheral wall 103 is arranged along an edge of the base 101 and surrounds the inner peripheral wall 102. The inner peripheral wall 102 and the outer peripheral wall 103 are both perpendicular to the base 101. An accommodating space 104 is defined by the base 101, the inner peripheral wall 102, and the outer peripheral wall 103. The transmitting assembly 1 is arranged in the accommodating space 104, and the first coil portion 11 surrounds the inner peripheral wall 102.

More specifically, the first coil portion 11 includes a 1st coil to an nth coil stacked from inside to outside, and n is a positive integer greater than 1. As mentioned in the previous paragraph, the first coil portion 11 is formed by winding the flat wire. The flat wire is different from the single-core wire or a multi-strand enameled wire, and the cross-section thereof (as shown in FIG. 3) has a rectangular shape. Therefore, each of the coils has two wide surfaces 111 that are opposite to each other and two narrow surfaces 112 that are opposite to each other, and lengths of the wide surfaces 111 are greater than lengths of the narrow surfaces 112. The two wide surfaces 111 are perpendicular to a surface of the base 101, and the two narrow surfaces 112 are parallel to the surface of the base 101. In other words, when the flat wire is wound to form the first coil portion 11, each of the coils is wound and arranged on the magnetic housing 10 in a vertical (or upright) manner. The two wide surfaces 11 of each of the coils are perpendicular to the surface of the base 101, and the wide surfaces 111 of two adjacent ones of the coils are in contact with each other. The two narrow surfaces 112 of each of the coils are parallel to the surface of the base 101, and one of the narrow surfaces 112 is in contact with the base 101.

In the present embodiment, the second coil portion 21 is also formed by winding one flat wire. The second coil portion 21 has the same material and structural configuration as those of the first coil portion 11, and the winding is also performed in a vertical (or upright) manner, details of which will not be reiterated herein. In addition, it is worth mentioning that the receiving assembly 2 of the present disclosure can also include a magnetic material (not shown in the drawings) to shield interference from metal objects and other electronic components, and the magnetic material mainly includes ferrite.

Furthermore, it should be noted that in the transceiving induction coil device for wireless charging Z provided by the present disclosure, the first coil portion 11 or the second coil portion 21 can be customized according to practical requirements. Therefore, in the present disclosure, no restrictions are placed on specific structures and dimensions (e.g., a thickness of the coils, a number of turns, a charging distance or an area of inductive coupling) of the first coil portion 11 or the second coil portion 21.

### Second Embodiment

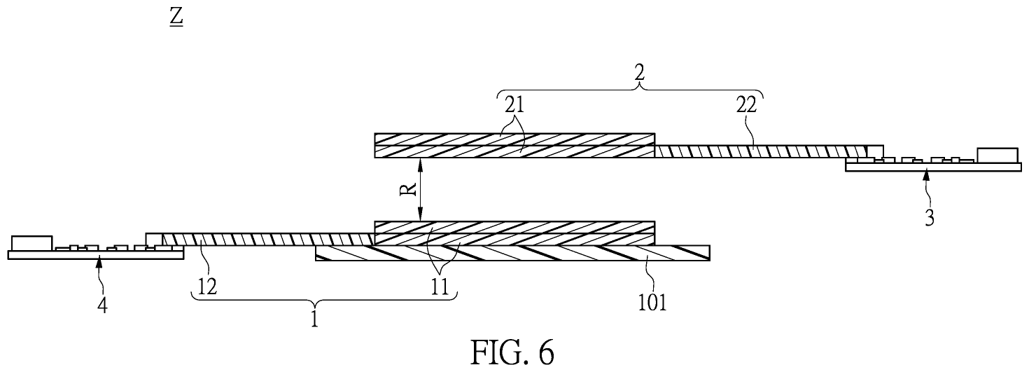

As shown in FIG. 2, FIG. 4, and FIG. 6, a second embodiment of the present disclosure provides another transceiving induction coil device for wireless charging Z, which includes a transmitting assembly 1 and a receiving assembly 2. The transmitting assembly 1 includes a plurality of first coil portions 11 and a magnetic housing 10. The plurality of first coil portions 11 are arranged on the magnetic housing 10 in a stacked manner, and the plurality of first coil portions 11 are each formed by winding one flat wire. The receiving assembly 2 includes a plurality of second coil portions 21 that are stacked upon each other. The receiving assembly 2 and the transmitting assembly 1 are coupled to each other, the transmitting assembly 1 is located below the receiving assembly 2, and a predetermined distance R is defined between the transmitting assembly 1 and the receiving assembly 2.

In other words, the present embodiment is mainly different from the first embodiment in that, the transmitting assembly 1 includes the plurality of first coil portions 11 that are arranged on the magnetic housing 10 in a stacked manner, and the receiving assembly 2 includes the plurality of second coil portions 21 that are stacked upon each other.

As shown in FIG. 4, the magnetic housing 10 includes a base 101, an inner peripheral wall 102, and an outer peripheral wall 103. The inner peripheral wall 102 is arranged at a center of the base 101. The outer peripheral wall 103 is arranged along an edge of the base 101 and surrounds the inner peripheral wall 102. The inner peripheral wall 102 and the outer peripheral wall 103 are both perpendicular to the base 101. An accommodating space 104 is defined by the base 101, the inner peripheral wall 102, and the outer peripheral wall 103. The transmitting assembly 1 is arranged in the accommodating space 104, and the plurality of first coil portions 11 surround the inner peripheral wall 102.

Similarly, in the present embodiment, the plurality of first coil portions 11 each include a 1st coil to an nth coil stacked from inside to outside, and n is a positive integer greater than 1. The plurality of first coil portions 11 are each formed by winding the flat wire. The flat wire is different from a single-core wire or a multi-strand wire, and a cross-section thereof (as shown in FIG. 4) has a rectangular shape. Therefore, each of the coils has two wide surfaces 111 that are opposite to each other and two narrow surfaces 112 that are opposite to each other, and lengths of the wide surfaces 111 are greater than lengths of the narrow surfaces 112. The two wide surfaces 111 are perpendicular to a surface of the base 101, and the two narrow surfaces 112 are parallel to the surface of the base 101. In other words, when the flat wires are wound to form the plurality of first coil portions 11, each of the coils is wound and arranged on the magnetic housing 10 in a vertical (or upright) manner. The two wide surfaces 11 of each of the coils are perpendicular to the surface of the base 101, and the wide surfaces 111 of two adjacent ones of the coils are in contact with each other. The two narrow surfaces 112 of each of the coils are parallel to the surface of the base 101, and one of the narrow surfaces 112 of the coil that is located at a lowest position is in contact with the base 101.

### Beneficial Effects of the Embodiments

In conclusion, one of the beneficial effects of the present disclosure is that, in the transceiving induction coil device for wireless charging Z provided by the present disclosure, by virtue of “the first coil portion of the transmitting assembly being formed by winding one flat wire” and “the second coil portion of the receiving assembly being formed by winding another flat wire”, charging coils are enabled to have a smallest direct current resistance (DCR) within a limited mechanical space of a device, and requirements in connection with electrical properties such as inductance and quality factor (Q value) can be satisfied at the same time, so as to increase an overall performance of wireless charging.

More specifically, the transceiving induction coil device for wireless charging Z provided by the present disclosure is mainly used in a magnetic induction wireless charging structure (wireless charger). In a wireless charging design, through winding the flat wire, the transceiving induction coil device for wireless charging Z is capable of actuating transmission and reception of electrical energy, and can be reduced in volume and improved in charging performance. Further, its range of application in various miniaturized products (e.g., wearable devices, watches, mobile phones, and TWS (true wireless stereo) earphones) can be expanded.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A transceiving induction coil device for wireless charging, comprising:
a transmitting assembly including a first coil portion and a magnetic housing, wherein the first coil portion is arranged on the magnetic housing, and the first coil portion is formed by winding one flat wire; and
a receiving assembly including a second coil portion;
wherein the receiving assembly and the transmitting assembly are coupled to each other, the transmitting assembly is located below the receiving assembly, and a predetermined distance is defined between the transmitting assembly and the receiving assembly.

2. The transceiving induction coil device for wireless charging according to claim 1, wherein the second coil portion is formed by winding another flat wire.

3. The transceiving induction coil device for wireless charging according to claim 1, wherein the magnetic housing includes a base, an inner peripheral wall, and an outer peripheral wall, the inner peripheral wall is arranged at a center of the base, the outer peripheral wall is arranged along an edge of the base and surrounds the inner peripheral wall, and the inner peripheral wall and the outer peripheral wall are perpendicular to the base; wherein an accommodating space is defined by the base, the inner peripheral wall, and the outer peripheral wall, the transmitting assembly is arranged in the accommodating space, and the first coil portion surrounds the inner peripheral wall.

4. The transceiving induction coil device for wireless charging according to claim 3, wherein the first coil portion includes a 1st coil to an nth coil stacked from inside to outside, n is a positive integer greater than 1, and each of the coils has two wide surfaces that are opposite to each other and two narrow surfaces that are opposite to each other; wherein the two wide surfaces are perpendicular to a surface of the base, and the two narrow surfaces are parallel to the surface of the base.

5. A transceiving induction coil device for wireless charging, comprising:
a transmitting assembly including a plurality of first coil portions and a magnetic housing, wherein the plurality of first coil portions are arranged on the magnetic housing in a stacked manner, and the plurality of first coil portions are each formed by winding one flat wire; and
a receiving assembly including a plurality of second coil portions that are stacked upon each other;
wherein the receiving assembly and the transmitting assembly are coupled to each other, the transmitting assembly is located below the receiving assembly, and a predetermined distance is defined between the transmitting assembly and the receiving assembly.

6. The transceiving induction coil device for wireless charging according to claim 5, wherein the plurality of second coil portions are each formed by winding another flat wire.

7. The transceiving induction coil device for wireless charging according to claim 5, wherein the magnetic housing includes a base, an inner peripheral wall, and an outer peripheral wall, the inner peripheral wall is arranged at a center of the base, the outer peripheral wall is arranged along an edge of the base and surrounds the inner peripheral wall, and the inner peripheral wall and the outer peripheral wall are perpendicular to the base; wherein an accommodating space is defined by the base, the inner peripheral wall, and the outer peripheral wall, the transmitting assembly is arranged in the accommodating space, and the plurality of first coil portions surround the inner peripheral wall.

8. The transceiving induction coil device for wireless charging according to claim 7, wherein the plurality of first coil portions each include a 1st coil to an nth coil stacked from inside to outside, n is a positive integer greater than 1, and each of the coils has two wide surfaces that are opposite to each other and two narrow surfaces that are opposite to each other; wherein the two wide surfaces are perpendicular to a surface of the base, and the two narrow surfaces are parallel to the surface of the base.
